(19) United States
(12) Patent Application Publication
(10) Pub. No.: US 2004/0242202 A1
(43) Pub. Date: Dec. 2, 2004

(54) System, apparatus, and method for automated handling of messages in terminals

(76) Inventor: Marko Torvinen, Espoo (FI)

Correspondence Address: Crawford Maunu PLLC, Suite 390, 1270 Northland Drive, St. Paul, MN, 55120, US

(21) Appl. No.: 10/436,875

(22) Filed: May 12, 2003

(51) Int. Cl. H04Q 7/20

(52) U.S. Cl. 455/412.1; 455/466

(57) ABSTRACT

A system, apparatus, and method for automatically receiving, parsing, and sorting received messages according to the message type. Separate buffers are maintained within the mobile terminal to accommodate messages of a specific type. Automatic or manual transfer of received messages is provided to further enhance proper placement of received messages. Once stored, the user of the mobile terminal may view the received messages using a varying number of display options that reduce the user's workload.

### FIELD OF THE INVENTION

This invention relates in general to message handling, and more particularly, to parsing, storing, and displaying messages in a mobile terminal according to the message type.

### BACKGROUND OF THE INVENTION

The mobile terminal has evolved from a simple, voice only communication tool, into a fully operational network device. Where the mobile terminal was once relegated to providing its user with point to point, bandwidth limited voice only communications, today's mobile terminal allows its user to become fully integrated into not only its home mobile network, but also to virtually any network that is accessible from its home mobile network. Accordingly, the mobile terminal has evolved from simply offering full-duplex voice connectivity, to offering a wide variety of rich communication types such as text messaging, imaging, video clips, etc.

One of the most successful technologies responsible for the technological evolution of the mobile terminal is the Short Message Service (SMS). SMS emerged as a standard application service of the Global System for Mobile Communications (GSM) network for either one-way or two-way delivery of short text messages from one mobile terminal to another. Currently, SMS is also being utilized to offer value added services, e.g., chat, e-mail notification, weather information, banking transactions, sports news, and airline information services. Extensions have been made to SMS, such as the Enhanced Messaging Service (EMS) for the delivery of multimedia content over SMS. EMS supports, for example, ringing tones, operator logos, picture messages, business cards, and internet access configuration data.

Additionally, the Multimedia Messaging Service (MMS) is an emerging mobile application service for one-way or two-way delivery of multimedia messages. MMS promises to provide the consumer with messaging services that allow not only the delivery of multimedia content but a broad spectrum of advanced mobile messaging based services. Since MMS supports a wide variety of content formats, it can also be seen as a technology that enables numerous services that are not limited to just person-to-person messaging. Hence, MMS can further be utilized as middleware for countless services that will function in the mobile domain. Both push and pull MMS content will be available that can take the form of headline news, daily cartoon strips, commercial advertisements, etc.

E-mail represents another messaging based service that has been evolving for over the last several decades. Today, e-mail is defined by the standards of the Internet Engineering Task Force (IETF). E-mail is a key application service for all segments of the mobile and Web domains and it will remain one of the most important and highly used forms of communication.

Whether the messaging system being used by a particular mobile terminal is SMS, MMS, e-mail, etc., the mobile terminal is susceptible to receipt of unsolicited messages. For example, advertisements and other commercial messages can be distributed to the mobile terminal in a manner similar to the proliferation of unsolicited e-mails affecting fixed computing devices coupled to the Internet. These unsolicited messages are generally referred to as “spam” and may or may not be considered by the mobile terminal user to provide value added content. The spam messages nevertheless are “mixed” in with other messages that the mobile terminal user considers to provide value added content. As a result, the spam messages tend to clutter the mobile terminal's message memory, causing the mobile terminal user to “filter” through the entire message memory space to parse out the wanted messages from the unwanted messages. A message received from a friend, for example, is currently treated in today's mobile terminal in the same manner as an unsolicited message received from an advertiser. Both message types receive equal priority, thus requiring the mobile terminal user to constantly manage the message memory space within the mobile terminal.

Additionally, mobile terminal users tend to keep their mobile terminals close to their sides throughout the day. As the unsolicited messages are received by the mobile terminal, they tend to interrupt the user, since a message receipt notification is generally delivered to the user via one of visual, audible or tactile means. Prior art mobile terminal messaging systems, therefore, tend to increase user interaction with the mobile terminal regardless of the importance of the received message. Prior art mobile terminal messaging systems do not allow the user to control incoming spam messages, nor do they allow the user to easily separate the wanted messages from those that are unwanted. Further, prior art mobile terminal messaging systems allocate only a single memory space to all messages. It is conceivable, therefore, that unwanted messages may entirely fill the memory space, whereby the wanted messages are blocked from the user by the less important and unwanted spam messages. Still further, the prior art mobile terminal messaging systems unduly increase the user's workload, since the user is required to manually parse through the entire set of received messages in order to access and react to the important messages, while discarding the unwanted messages.

Accordingly, there is a need in the communications industry for a system, apparatus, and method that provides the mobile terminal user with a means to customize the mobile terminal's messaging system according to his or her needs. The user should be provided with a messaging system that enhances the user's ability to respond to important messages, while reducing the user's workload with respect to unwanted messages. The present invention fulfills these and other needs, and offers other advantages over the prior art.

### SUMMARY OF THE INVENTION

To overcome limitations in the prior art, and to overcome other limitations that will become apparent upon reading and understanding the present specification, the present invention discloses a system, apparatus, and method for receiving, identifying, and sorting received messages according to type.

In accordance with one embodiment of the invention, a messaging system is provided. The messaging system comprises a repository for messages received from a plurality of message sources within a network and a plurality of mobile terminals coupled to receive the messages from the repository. The mobile terminals comprise a message identifier coupled to determine the message type of each received message, and a plurality of message queues coupled to receive each message according to its message type.

In accordance with another embodiment of the invention, a mobile terminal wirelessly coupled to a network in provided, which includes a network element capable of delivering messages to the mobile terminal. The mobile terminal comprises a memory capable of storing at least one of a message identifier and a plurality of message buffers, a processor coupled to the memory and configured by the message identifier to sort messages received from the network element into the plurality of message buffers according to a message type of messages received, and a transceiver configured to facilitate the message exchange with the network element.

In accordance with another embodiment of the invention, a computer-readable medium having instructions stored thereon which are executable by a mobile terminal for facilitating message receipt is provided by performing steps comprising: receiving a message from a network element; determining a message type of the message received; and storing the message into one of a plurality of message buffers according to the message type.

In accordance with another embodiment of the invention, a method for receiving messages in a mobile terminal is provided. The method comprises determining the message type of the received message and sorting the message into one of a plurality of message buffers in response to the message type.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

The invention is described in connection with the embodiments illustrated in the following diagrams.

FIG. 1 is a representative system level implementation of a multimedia messaging system in accordance with the present invention;

FIG. 2 illustrates a representative structure of an Multimedia Messaging Service (MMS) Protocol Data Unit (PDU);

FIG. 3 illustrates an Hyper Text Transfer Protocol (HTTP) encapsulation of an Multimedia Messaging Service (MMS) message;

FIG. 4 illustrates an exemplary parsing block diagram according to the principles of the present invention;

FIGS. 5, 6, and 7 illustrate exemplary embodiments of screen displays of sorted messages according to the present invention;

FIG. 8 illustrates a representative mobile computing arrangement in accordance with the present invention; and

FIG. 9 illustrates an exemplary flow diagram of a method according to one embodiment of the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method to allow the user of a mobile terminal greater flexibility in his or her interaction with the mobile terminal's messaging system. Messages received by the mobile terminal may be parsed into separate message queues and presented to the user according to his preferences. Exemplary configuration parameters that may be selectable by the user include: depth selection of each message queue required by the user; determination of the message queue for use for each received message; and configuration of the alert mode of the mobile terminal according to the corresponding priority of each received message. Accordingly, each message is stored and displayed according to its type and priority so that the user may attend to the important messages, while saving the unimportant messages for viewing at his or her leisure.

It should be noted that the present invention may be used in conjunction with virtually any mobile messaging technology, such as SMS and MMS, and may be extended to e-mail, or even instant messaging applications as well. In order to provide a description of the advantages of the present invention, an MMS messaging system is used, but it is not intended to limit the scope of the invention in any way.

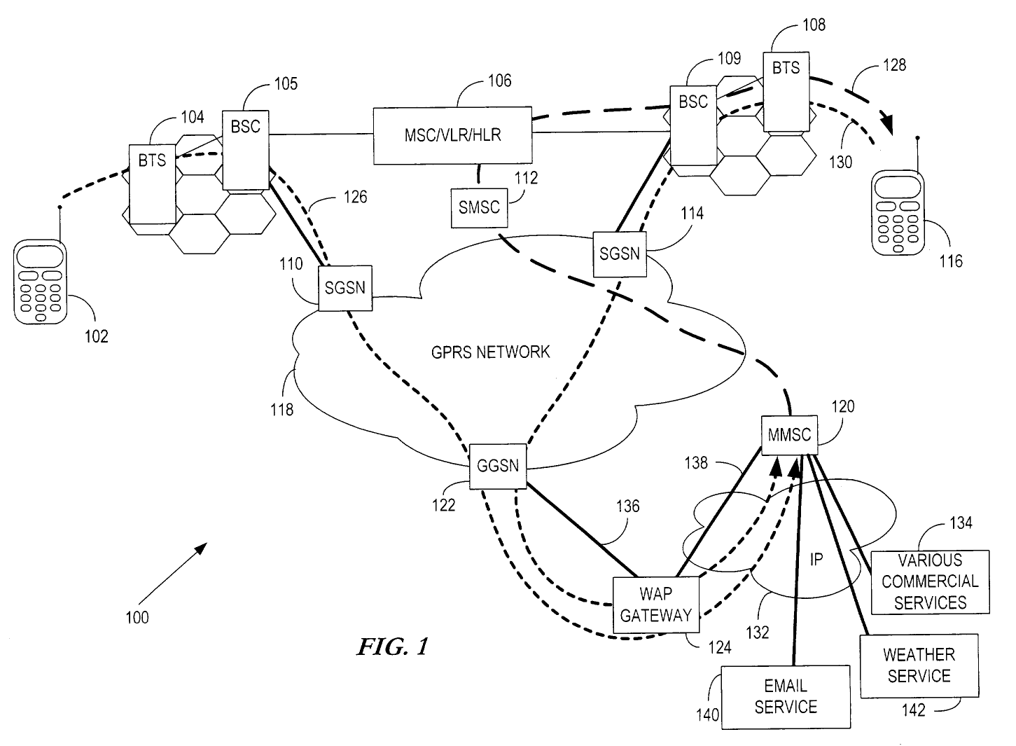

MMS is based on a store and forward model, whereby content from a content source is forwarded to a content sink via, for example, General Packet Radio Service (GPRS) network 118 as illustrated in FIG. 1. FIG. 1 illustrates exemplary multimedia messaging system 100 using GPRS as the communications backbone. GPRS is a packet-switched service for GSM that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. SGSN 110 and 114 are ultimately coupled to SMSC 112 and/or MMSC 120 in connection with the presently described embodiment. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124 via link 136.

Multimedia Messaging Service Center (MMSC) 120 provides messaging capabilities for the delivery of multimedia messages composed of text, photographs, video, and other media types. The messaging capabilities include mobile originated messages sent to other mobile terminals or applications and application originated messages sent to mobile terminals or other applications. MMSC 120 is responsible for storing incoming and outgoing MMS messages, as well as the transfer of messages between different messaging systems, e.g., e-mail service 140. In addition, MMSC 120 may provide an External Application Interface (EAIF) (not shown) that allows application developers and service providers to connect to MMSC 120, via IP network 132 for example, to offer value added services to mobile subscribers, such as weather service 142 and various commercial services 134.

With the aforementioned network system described as a representative network environment, a store and forward messaging scenario is now described in which a Wireless Application Protocol (WAP) Push Framework is utilized. Dashed line 126 represents the source multimedia message from mobile terminal 102, which is ultimately posted to MMSC 120 via links 136 and 138. The WAP protocol suite is used as the data transport mechanism because WAP provides data transport services that are optimized for mobile networks. WAP also provides uniform transport services regardless of the underlying network.

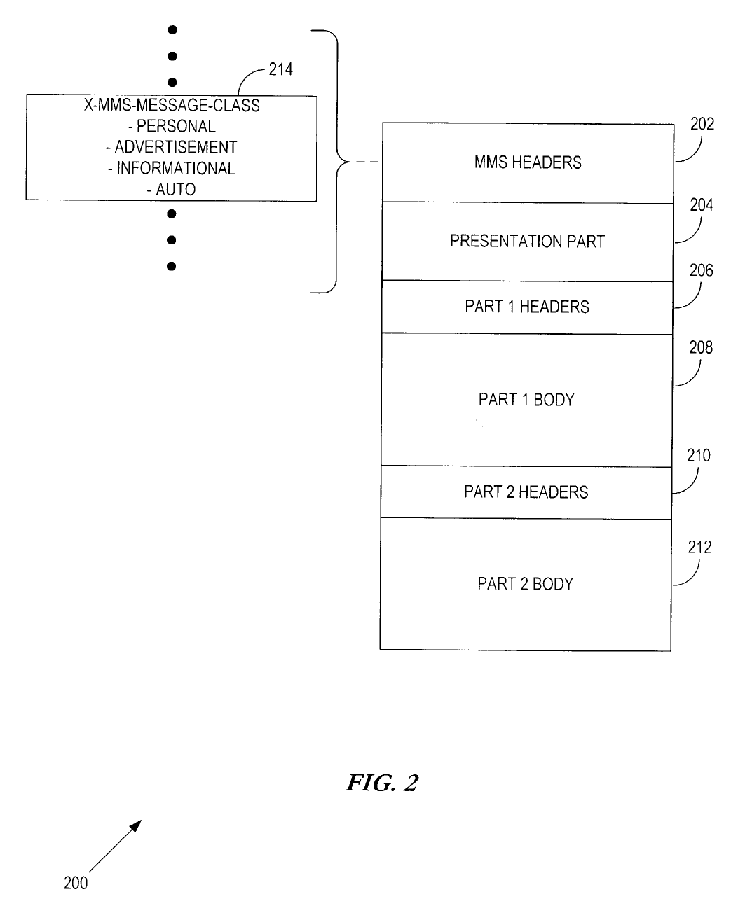

In particular, the Wireless Session Protocol (WSP) layer supplies the basis of the transport mechanism. FIG. 2 illustrates an exemplary MMS Protocol Data Unit (PDU) 200 that may be supplied by mobile terminal 102 during a posting of content to MMSC 120. MMS Headers 202 mainly contain information as to how to transfer the PDU from the originator, e.g. mobile terminal 102, to the destination, e.g. mobile terminal 116. The information may contain such information as source unit identification, sink unit identification, message identification, content type, etc. Presentation part 204 is an optional component of PDU 200 that contains information as to how the content contained within PDU 200 should be rendered onto Input/Output (I/O) of the destination device, e.g. display, speakers, tactile feedback, etc. Part 1 headers 206 and Part 2 headers 210 contain, for example, content indicators that indicate the type of content contained by Part 1 body 208 and Part 2 body 212, respectively. The content type may be any content type supported by MMS such as video, images, e.g., JPEG or GIF format, and text, e.g. plain or formatted text, to name only a few. Part 1 and Part 2 headers, 206 and 210 respectively, may also contain the location of the content in terms of its file name, e.g. image.jpeg or text.plain.

X-MMS-Message Class header 214 is one of many optional headers that may exist within MMS header 202. X-MMS-Message Class header 214 is used to indicate the class of the MMS message, so that the receiving end of the message may interpret the received message type. Four values of X-MMS-Message-Class 214 exist: personal; advertisement; informational; and auto. Since X-MMS-Message Class header 214 is optional, the “personal” class is the default setting used when the header does not accompany the message. When the message is sent as part of an advertisement from various commercial services 134 of FIG. 1, for example, a message class of “advertisement” will be used so that mobile terminal 116 may place the message into its “advertisement” queue, in accordance with the present invention.

Returning to FIG. 1, MMS messages are sent by mobile terminal 102 for delivery to mobile terminal 116 in, for example, an M-Send.req PDU which contains the Multipurpose Internet Mail Extensions (MIME) encapsulated MMS message content. Either the address of mobile terminal 102 or a token representing the address of mobile terminal 102 is provided within the PDU, along with the content type of the PDU. Dashed line 126 of FIG. 1 indicates the M-Send.req PDU message flow from mobile terminal 102 to MMSC 120. While WSP provides the wireless transport from mobile terminal 102 to WAP gateway 124, Hyper Text Transfer Protocol (HTTP) is used to complete the post request message progression to MMSC 120. WAP gateway 124 provides the necessary functionality required to support HTTP encapsulation as required to support multimedia messaging to MMSC 120.

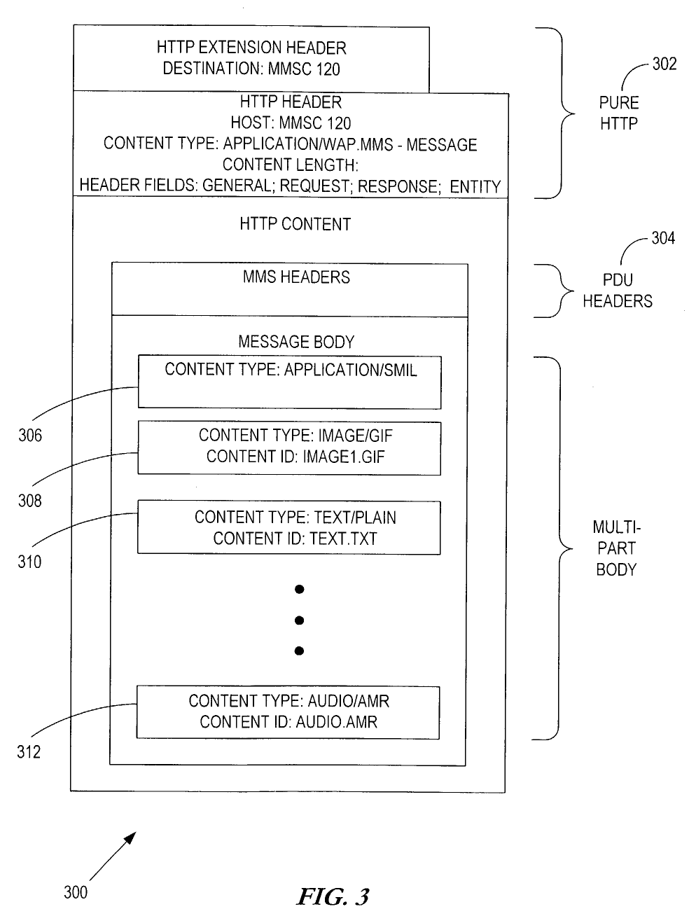

FIG. 3 illustrates HTTP Post Request encapsulation 300 that is required to present the M-Send.req PDU received from mobile terminal 102 to MMSC 120. Pure HTTP 302 contains both the optional HTTP Extension Header and the HTTP Header. The HTTP Extension Header may provide such information as message ID, message status, charging information (tariff classes), message recipient, message sender, message type (MMS), and MMSC version. The HTTP Header provides mandatory information such as HOST: e.g., MMSC 120; CONTENT TYPE: e.g., MMS message; and CONTENT LENGTH: indicating the length of the multi-body part comprised of, for example, body part components 306-312. In addition, the HTTP Header may contain other header fields denoted as general, request, response and entity. These additional header fields provide functionality control that is invoked by the source of the MMS message and executed by the recipient of the MMS message. Cache control may be invoked by mobile terminal 102, for example, causing MMSC 120 to provide cache operations in response to the received MMS message.

The message body of HTTP encapsulation 300 comprises PDU headers 304, i.e., MMS headers 202, and any number of binary encoded, MIME message parts, where the illustrated content type is application/vnd.wap.mms-message. Message part 306 indicates a content type of Synchronized Multimedia Integration Language (SMIL) that was generated, for example, from a URL accessed by mobile terminal 102 that further referenced SMIL content. Message part 308 indicates that a GIF image exists at location “IMAGE1.GIF”, which is followed by message part 310 containing plain text at location “TEXT.TXT”. Finally, the last message part 312 provides audio content from an Adaptive Multi-Rate (AMR) codec format at location “AUDIO.AMR”.

Once HTTP encapsulated Post Request message 300 has been transmitted to MMSC 120 by WAP gateway 124, an indication as to the receipt of the content is provided to mobile terminal 116, which is denoted by dashed line 128. Notification 128 utilizes push semantics such as those defined by the Open Mobile Alliance (OMA), which delivers a receipt notification to the receiving device, e.g., mobile terminal 116, via for example, an SMS bearer and Short Message Service Center (SMSC) 112. The MMS PDU that is used to send the notification message within the push message is M-Notification.ind. The M-Notification.ind informs mobile terminal 116 about the contents of received message 126 and its purpose is to allow mobile terminal 116 to fetch multimedia message 126 from MMSC 120 via path 130. The Notification PDU consists of MMS headers which define characteristics of the multimedia message such as: size of the multimedia message in octets; and the location of the multimedia message, e.g., MMSC 120. Once notification message 128 has been received, a WAP/GET operation may either be automatically or manually initiated in order to receive the content specified by the URI of the notification message. Once the content has been received by mobile terminal 116, notification to the source, e.g., mobile terminal 102, is provided indicating successful receipt of the content.

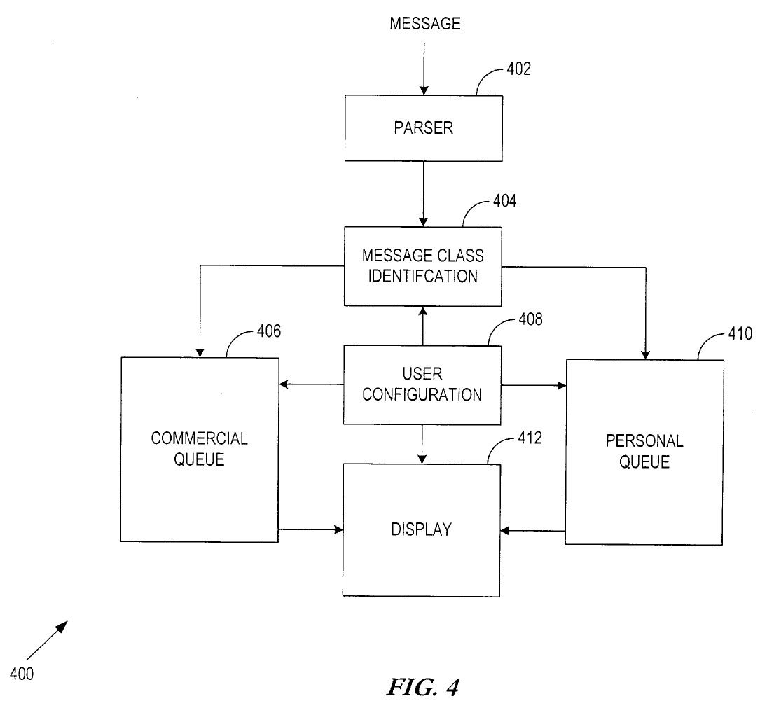

Once the message has been received by mobile terminal 116, further processing of the message takes place in accordance with the principles of the present invention. FIG. 4 represents an exemplary functional block diagram that illustrates the post processing of all received messages in accordance with one embodiment of the invention. In the illustrated embodiment, the message is received by parser 402 and each header component of MMS headers 202 is parsed and submitted to message class identification 404. Message class identification 404 receives the parsed X-MMS-Message class header 214 contained within MMS headers 202. Based upon the value of X-MMS-Message class header 214, the class of the message may be characterized as one of personal, advertisement, informational, or automatic. Once the message class has been determined, the message may subsequently be transferred to commercial queue 406 or personal queue 410, depending upon the value of the class identifier. If the class header is absent, or otherwise contains un-initialized data, the class of the message will default to personal.

User configuration 408 allows the configuration of the messaging operation within, for example, mobile terminal 116 of FIG. 1. User configuration 408 may represent a configuration based upon user options that have been factory preset, customized by the mobile terminal's user, configured at provisioning time, etc. User options that are set by user configuration 408 affect the operational aspects of message class identification 404, commercial queue 406, personal queue 410, and display 412.

In particular, the operation of message class identification 404 depends upon operational parameters set by user configuration 408. All messages marked with a message class of “advertisements,” for example, may be placed into commercial queue 406. Likewise, all messages marked with a message class of “personal” (or alternatively simply not marked with the message class of “advertisements”) may be placed into personal queue 410. Such a separation scheme allows for automated handling of commercial message types received from, for example, various commercial services 134 and personal message types received from, for example, mobile terminal 102. All commercial messages received are routed to commercial queue 406 and are physically separated from personal messages routed to personal queue 410.

In one embodiment of the present invention, commercial queue 406 represents a separate buffer from the main message buffer (not shown). Commercial queue 406 may provide circular capability, whereby separate read and write pointers are maintained to control data input to commercial queue 406 and data output from commercial queue 406. In such a case, each time a commercial message is received into commercial queue 406, the write pointer is incremented by one storage location. Once the write pointer has reached the end of the circular buffer, it will return to the beginning of commercial queue 406 and begin writing new messages there. The write pointer is said to be functioning in a circular pattern, and is, therefore, confined to one specific, user defined area of message memory. Similarly, each time a commercial message is accessed from commercial queue 406, the read pointer is incremented by one storage location. Once at the end of commercial queue 406, the read pointer resets itself to the beginning of commercial queue 406 to begin accessing messages from the top of commercial queue 406.

In such a circular operation, user configuration 408 may allow the write pointer to overtake the read pointer, such that the oldest of the commercial messages contained within commercial queue 406 are overwritten by newly arriving commercial messages. In this mode of operation, commercial queue 406 will accept and store any number of commercial messages received, whereby the user of the mobile terminal may, at his or her convenience, retrieve these commercial messages at any given time. If the user procrastinates and fails to access commercial queue 406 in a timely manner, however, he or she runs the risk of losing commercial messages that were previously received, but later overwritten. In an alternate mode of operation, user configuration 408 may prevent the write pointer from overtaking the read pointer, such that once commercial queue 406 has been filled with unread messages, no more commercial messages will be accepted. In such an instance, the user may then be prompted by the mobile terminal through visual, audible, or tactile means to access commercial queue 406 to make space for future commercial messages.

User configuration 408 may also allow the mobile terminal user to set the mode used by the mobile terminal to alert the user as to the presence of a new commercial message. The user may wish that no alert will be sent to indicate the arrival of a new commercial message, so that the user can eliminate any distraction caused by the arrival of an unwanted, unsolicited, or otherwise low priority message. In one embodiment, the user may wish to enable an alert only in the case that the read pointer is about to be overtaken by the write pointer so that any unread messages may be quickly accessed before they are overwritten. In another embodiment, the user may wish to receive an alert only when commercial messages are received that match the user's pre-defined criteria.

Personal queue 410 may be similarly configured through user configuration 408. In one embodiment, personal queue 410 may also be a circular buffer implementation. In another embodiment, however, personal queue 410 may be implemented using other topologies such as First In First Out (FIFO) or by linked list. In any event, the separation of commercial queue 406 and personal queue 410 allows the user to concentrate on message retrieval from personal queue 410, since this is the location of his or her most important messages. Once it is found that any message contained within commercial queue 406 is of importance, the user may then transfer the commercial message from commercial queue into permanent storage.

In an alternate embodiment, user configuration 408 may cause the transfer of commercial messages from commercial queue 406 to personal queue 410 to occur automatically. The user may, for example, configure the automatic transfer to take place in the event that any commercial advertisement is received that pertains to some pre-defined criteria. If, for example, the user happens to be on a specific diet, he or she may want to have any advertisement with the word “diet” anywhere within the subject line of the message to be automatically transferred to permanent storage with a subsequent, user defined alert. Additionally, the user may wish to configure the mobile terminal to alert him or her upon the arrival of any specific messages that relate to services previously ordered. For example, the user may have subscribed to weather updates from weather service 142 of FIG. 1 and he or she may wish for an automatic transfer of the weather update into permanent storage along with both an audible and tactile alert to indicate the automatic transfer.

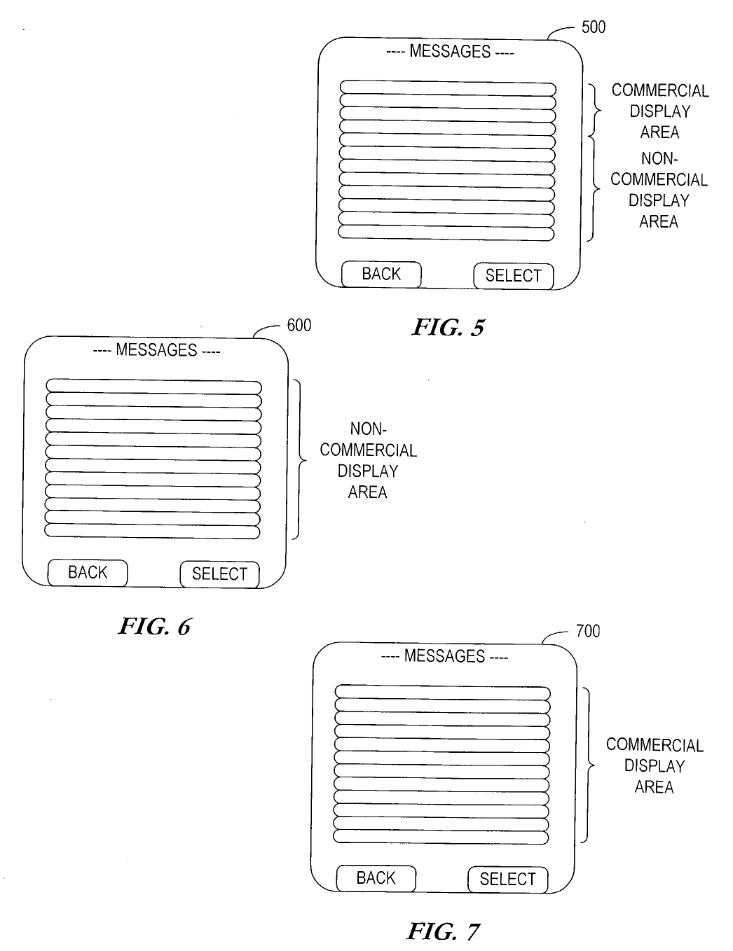

Display 412 may also be configured using user configuration 408 in accordance with the present invention. In one embodiment shown in FIG. 5, message display 500 is divided between a commercial display area and a non-commercial display area. The first four message locations of display 500, for example, are configured to display four commercial messages contained within commercial queue 406. The commercial display area may also be configured by user configuration 408 to sort the commercial messages according to time of arrival, subject, etc. The remaining message locations of display 500 are reserved for personal messages from personal queue 410 and may be similarly sorted.

In another embodiment according to the present invention, the user is able to toggle between displaying non-commercial and commercial messages only. FIG. 6 illustrates display 600 selected to display only non-commercial messages retrieved from personal queue 410. In such a configuration, the user views only those messages that are of importance to him or her. The display is not cluttered with unimportant commercial messages that may detract the user's attention from the more important personal messages. FIG. 7 illustrates alternative display 700, whereby only commercial messages from commercial queue 406 are displayed. From this screen, the user can quickly scan the list of commercial messages that may be of interest to him or her. Any commercial messages that are of interest can then be transferred from commercial queue 406 into permanent storage, e.g., personal queue 410, for subsequent retrieval at a later time.

The separation of personal messages from the commercial messages provides the user with several advantages. First, the user has better control over commercial messaging, e.g., advertisements, that are sent to his or her mobile terminal. Further, the user is relieved of the laborious task of separating important personal messages from the less important commercial messages. Older commercial messages may be deleted automatically, thus further reducing the user's workload concerning unwanted messages. Another advantage is that commercial messages may be totally disregarded by the user at his option. Additionally, the amount of mobile advertisements incident to the user's mobile terminal may be increased without any increased amount of irritation or labor to the user when attempting to access important messages from the personal queue. Another advantages is that personal memory storage does not compete with commercial memory storage, thus allowing any number of commercial messages to be received without risk of preventing the receipt of the more important personal messages. Further, a separate alert mode, whether it is silent, audible, visual, and/or tactile, may be configured for all received and/or transferred commercial messages. The present invention also provides additional advantages in addition to the these representative advantages.

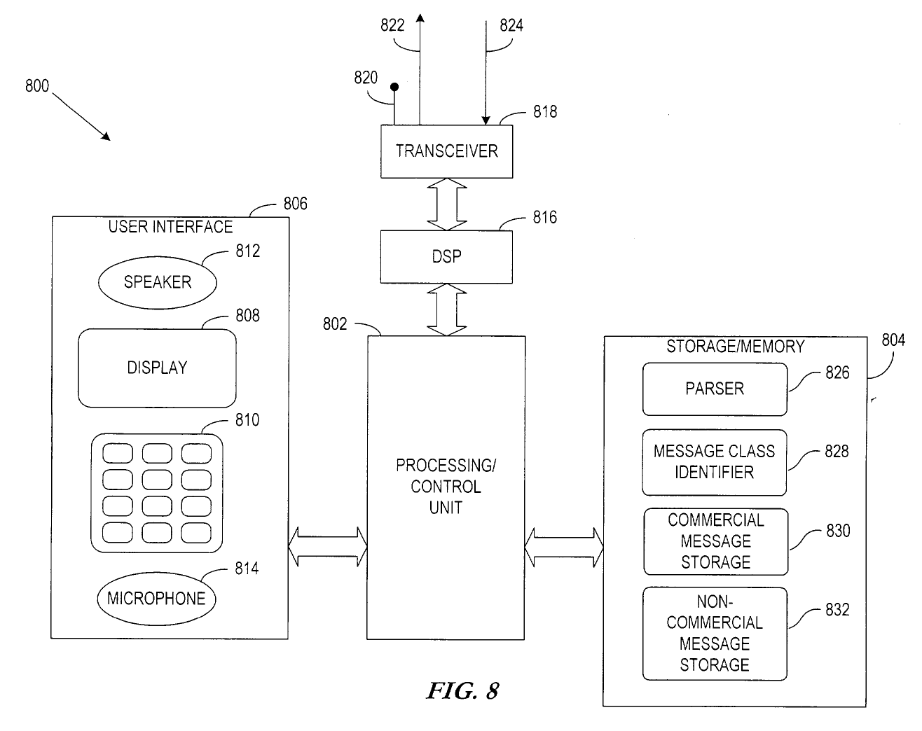

The invention is a modular invention, whereby processing functions within a mobile terminal may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various parsing and message identification functions described herein. An example of a representative mobile terminal computing system capable of carrying out operations in accordance with the invention is illustrated in FIG. 8. Those skilled in the art will appreciate that the exemplary mobile computing environment 800 is merely representative of general functions that may be associated with such mobile devices, and also that landline computing systems similarly include computing circuitry to perform such operations.

The exemplary mobile computing arrangement 800 suitable for parsing and message identification functions in accordance with the present invention may be associated with a number of different types of wireless devices. The representative mobile computing arrangement 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile terminal, and also those functions associated with the present invention as dictated by parser 826 and message class identifier 828 available in the program storage/memory 804. Thus, the processing unit 802 is capable of initiating parsing and message identification functions associated with the present invention. Parser 826 may be invoked once a message has been received by mobile terminal 800 in order to determine the class of the received message. Message class identifier 828 may then be invoked to sort the message into commercial message storage 830 or non-commercial message storage 832. The program storage/memory 804 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 804 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 800 via data signals, such as being downloaded electronically via one or more networks, such as the Internet and an intermediate wireless network(s).

The processor 802 is also coupled to user-interface 806 elements associated with the mobile terminal. The user-interface 806 of the mobile terminal may include, for example, a display 808 such as a liquid crystal display, a keypad 810, speaker 812, and microphone 814. These and other user-interface components are coupled to the processor 802 as is known in the art. Other user-interface mechanisms may be employed, such as voice commands, switches, touch pad/screen, graphical user interface using a pointing device, trackball, joystick, or any other user interface mechanism.

The mobile computing arrangement 800 also includes conventional circuitry for performing wireless transmissions. A digital signal processor (DSP) 816 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 818, generally coupled to an antenna 820, transmits the outgoing radio signals 822 and receives the incoming radio signals 824 associated with the wireless device.

The mobile computing arrangement 800 of FIG. 8 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system and method in accordance with the present invention.

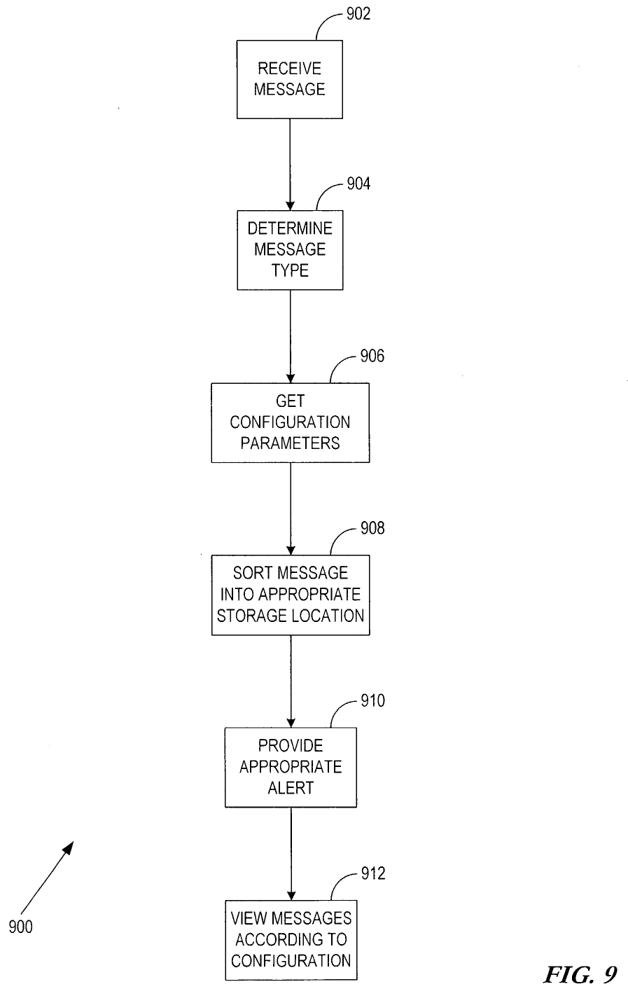

Flow diagram 900 of FIG. 9 illustrates an exemplary parse and sort flow diagram for received messages according to the principles of the present invention. A message is received by the mobile terminal in step 902, whereby the message may be of any type including SMS, MMS, e-mail, etc. The message type, e.g., commercial or personal, is determined in step 904. In one embodiment where the message is an MMS message, the class of the message is parsed from the message class field of the X-MMS-Message-Class header contained within the M-Send.req message PDU. In step 906, configuration parameters are retrieved to determine the functionality that the user requires in dealing with the newly received message. For example, the user may have selected that all messages should be transferred to permanent message storage, regardless of message class. Alternately, the user may wish to parse any received messages into their respective message buffers according to their message class. In step 908, the message is then stored according to the user preferences and an appropriate alert is provided in step 910. The message received alert is also configurable to be one of silent, audible, visual, tactile, or any combination thereof. Once the message has been appropriately sorted and stored, the user may then view all received messages in accordance with the user configurable display screen as in step 912.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A messaging system comprising:
a repository for messages received from a plurality of message sources within a network;
a plurality of mobile terminals coupled to receive the messages from the repository, wherein the mobile terminals comprise:
a message identifier coupled to determine the message type of each received message; and
a plurality of message queues coupled to receive each message according to its message type.

2. The messaging system according to claim 1, wherein the repository receives Short Message Service (SMS), Multimedia Messaging Service (MMS), and e-mail messages.

3. The messaging system according to claim 2, wherein the classification of the messages is contained within a class header of the message.

4. The messaging system according to claim 3, wherein the messages are classified as commercial messages.

5. The messaging system according to claim 4, wherein the messages are stored within a commercial message queue.

6. The messaging system according to claim 3, wherein the messages are classified as personal messages.

7. The messaging system according to claim 6, wherein the messages are stored within a personal message queue.

8. The messaging system according to claim 1, wherein the mobile terminals further comprise a display coupled to the plurality of message queues.

9. The messaging system according to claim 8, wherein the display is configured to display messages of different types.

10. The messaging system according to claim 8, wherein the display is configured to display messages of only one type.

11. A mobile terminal wirelessly coupled to a network which includes a network element capable of delivering messages to the mobile terminal, the mobile terminal comprising:
a memory capable of storing at least one of a message identifier and a plurality of message buffers;
a processor coupled to the memory and configured by the message identifier to sort messages received from the network element into the plurality of message buffers according to a message type of messages received; and
a transceiver configured to facilitate the message exchange with the network element.

12. The mobile terminal according to claim 11, further comprising a display coupled to the plurality of message buffers.

13. The mobile terminal according to claim 12, wherein the display is configured to display messages of different types.

14. The mobile terminal according to claim 12, wherein the display is configured to display messages of only one type.

15. A computer-readable medium having instructions stored thereon which are executable by a mobile terminal for facilitating message receipt by performing steps comprising:
receiving a message from a network element;
determining a message type of the message received; and
storing the message into one of a plurality of message buffers according to the message type.

16. A method for receiving messages in a mobile terminal, comprising:
determining the message type of the received message; and
sorting the message into one of a plurality of message buffers in response to the message type.

17. The method according to claim 16, further comprising establishing predefined parameters.

18. The method according to claim 17, wherein the messages are sorted in response to the predefined parameters.

19. The method according to claim 17, wherein the messages contained within the message buffers are displayed in response to the predefined parameters.

20. The method according to claim 19, wherein only one type of message is displayed.

21. The method according to claim 19, wherein a plurality of message types are displayed in accordance with the predefined parameters.
